(19) United States
(12) Patent Application Publication
(10) Pub. No.: US 2004/0237722 A1
(43) Pub. Date: Dec. 2, 2004

(54) Strip-shaped cutting tools

(76) Inventor: Helmut Ponemayr, Gradentheil (AU)

Correspondence Address: Cooper & Dunham, 1185 Avenue of the Americas, New York, NY, 10036, US

(21) Appl. No.: 10/482,586

(22) PCT Filed: Jun. 24, 2002
(86) PCT No.: PCT/AT02/00180

(30) Foreign Application Priority Data
Jun. 25, 2001 (AT) A 974-2001

(51) Int. Cl. B23D 63/00

(52) U.S. Cl. 76/112

(57) ABSTRACT

The invention relates to a process for producing a cutting tool, in particular saws, cutting rules or cutting dies, comprising a carrier material (1) in strip or disk form, to whose edge, which is substantially standing on end, a cutting-edge region (2) in the form of a pulverulent alloy is applied and melted during the application, preferably by means of a laser beam, and then solidifies on the edge.

The invention is distinguished by the fact that at least the cutting-edge region (2) which projects above the side face of the carrier material is subjected to a hot-working step in that region of the carrier band with pulverulent material already applied in which this material is solidifying.

According to a variant, the incidence of the laser beam on the material which is to be melted does not exceed the threshold intensity of the material for plasma formation.

The invention also relates to configurations, to a device for carrying out the process and to the tools or their blanks produced in this way.

The invention relates to the application of pulverulent alloys to carrier materials in strip, band or disk form which are substantially standing on end, for cutting tools, in particular saws, cutting rules or cutting dies, and to tools or their blanks produced in this way.

In particular band saws for machining metal have to satisfy a wide range of requirements to be economically usable: the strip material must be flexible and elastic, and it has to be able to withstand and absorb not only the tensile stresses to which the saw band is exposed even before mounting, but furthermore it also has to withstand the forces applying a flexural load to the band during the sawing operation and the torsional moments and stresses experienced by the band as it rotates about its longitudinal axis above and below the cutting table or in front of and behind the cutting location. The above loads are compounded by impact, jarring and dynamic loads caused by the engagement of the individual teeth into the material which is to be cut and, not least, the thermal load, which may reach 600° C. and above in the toothed region and in particular at the tooth tips. Since the cooling of the strip dissipates this heat, the strip is subject not only to this thermal load but also to the formation of a temperature gradient with the associated thermal stresses which are superimposed on the mechanical and in particular dynamic loads.

The processes described in the introduction and the associated devices have in recent times been used to an increasing degree in order to apply cutting edges which not only have a good cutting capacity but also a high wear resistance and other properties which significantly differ from those of the carrier material to carrier materials with defined mechanical properties, in particular a high toughness and good flexibility.

This makes it possible to create alloys and composite materials which cannot be produced by means of conventional processes, for example by welding a flat wire onto a carrier material.

In this case, the procedure is usually for the pulverulent material to be applied to the location which is in each case desired with the aid of a gas flow and in the process, partially in flight, partially once it has landed on the carrier material, being melted by a high-energy beam, generally a laser beam, resulting in the pulverulent material which is to be melted being welded to the edge region of the carrier material, resulting in the desired composite material. In this case, a relative movement is maintained between carrier material and the application location (in a similar manner to with conventional welding), leading to the formation of the desired strip of pulverulent material on the carrier material. It is also possible to repeat this operation and in this way to produce multilayer structures, in which case the individual successive layers may have identical or different chemical compositions.

In connection with this technology, reference is made in general terms to EP 0 931 180 B1, DE 199 09 390 C1, DE 32 16 456 A1, DE 25 42 001 A1. Less relevant prior art, which deals with the creation of sintered on layers and/or the welding of the carrier material to a flat wire and which cites alloys which can be used with particular success includes DE 125 49 36 A, EP 0 078 254 A2, AT 396 560 B. JP 62083480 A deals with the application of powder comprising hard particles to the surface of a body by rolling the red-hot body in the powder and then pressing the powder in, while U.S. Pat. No. 5,837,960 A deals with the application of powder to a substrate under the influence of a laser beam in order to build up an object layer by layer, with the build-up rates achieved being in the region of a few grams per minute, meaning that the process can only be used for precision mechanics problems.

WO 93/21360 A uses a laser to melt the surface layer of a coated workpiece in order to achieve desired surface properties by means of the remelting which is thereby brought about.

Another option is described in U.S. Pat. No. 4,488,882 A, corresponding to DE 32 16 456 A1. In this case, a cutting-edge region of a cutting tool is softened by means of a laser beam and particles of tungsten carbide or other hard materials with a size of from 0.3 mm to 1.5 mm are introduced into the regions which have been softened in this way. In this case, the base material of the cutting tool serves as a matrix, similarly to in the case of a grinding wheel, in which the actual cutting particles are located. This proposal is entirely unsuitable for saws which, by comparison, have “macroscopic”, in particular geometrically defined, material-removing regions, but also for cutting rules, etc.

As will be clear from the brief outline presented above, the region which consists of the pulverulent material is formed and joined to the carrier band, referred to below as the “cutting edge”, by melting the powder and a thin region of the edge of the carrier band, thus by a process which in metallurgical terms is similar to a welding process. The thermal load on the material is also similar to in a welding process, and the consequence of the powder being alloyed on is different microstructural formations during the solidification of the powder which has been applied and briefly liquefied and of the edge region of the carrier material, in a similar way to with a weld seam.

The most noticeable phenomenon, which is visible to the naked eye, is the external shape of the powder which has been melted on after it has solidified again, since the high surface tension typical of molten metals leads to the formation of a structure which is virtually circular in cross section, and therefore overall is in the form of a rod, on the edge of the carrier material.

The solidification, on a small scale, leads to all the particular features and metallurgical phenomena which are known on a large scale for example from the casting of ingots or from continuous casting, for example the formation of a special cast microstructure, etc.

During the further processing of these blanks, the laterally projecting structure in the form of a round rod is removed by a machining or grinding working step, and the cutting edge is converted into the desired shape. Since, as stated above, the microstructure in rod form consists of a particularly resistant material which is optimally suitable for the formation of a cutting edge, this machining or grinding operation is complex and expensive.

The object of the invention is to provide a process and a device for carrying out a process which enables the metallurgical and physical properties of the finished object, in particular in its cutting-edge region, to be significantly improved and which can be carried out economically even on an industrial scale.

According to the invention, this is achieved by virtue of the fact that the cutting-edge region, which has a cross section which is substantially in the form of a segment of a circle and which projects above the side face of the carrier band, is brought into the desired shape, generally substantially aligned with the two side planes of the carrier band, by a hot-working step in that region of the carrier band with melted pulverulent material already applied in which this material is solidifying.

This measure firstly means that during the subsequent final production of the cutting edge little or no material has to be removed from the sides of the carrier band, and secondly that the hot-working step, which at least partially destroys cast microstructures with a lattice-like structure formed during the solidification, specifically fragments this microstructure, resulting in a microstructure whose properties, in particular ductility, are significantly improved compared to the original microstructure.

Of course, it is not necessary (and in many cases also not desirable) to create a microstructure of the cutting-edge region which is accurately aligned with the side planes of the carrier band; when rolls are used to work the cutting-edge region which has just solidified, it is also possible to use conical or stepped rolls in order to achieve a desired cross section, and it is also possible to use rolls which have different diameters over their circumference, thereby creating a type of “constriction”. A constriction is to be understood as meaning both a thickness of the cutting-edge region obtained which varies over the length of the carrier band and a deformation of the cutting-edge region which is alternately directed more to one side and then more to the other side.

Of course, the rolls require intensive cooling and have to be equipped with a surface which is suitable to withstand the loads to which it is exposed, but the person skilled in the art of hot-working, when he is aware of the invention, will be readily able to select corresponding materials and surface conditions.

One measure of the invention which, although not related to the hot-working step according to the invention, is very closely technically related to the application of the powder, relates to the laser used and/or its control:

The application of metallic layers of a certain composition to metallic substrates of a different composition using a process such as that described above is known per se, but always relates to the application of such layers to surfaces, rather than to edges, such as the narrow sides of a carrier band. If the conventional process is applied to a situation of this nature, this will give results which are of no use whatsoever. However, according to the invention it has been discovered that if the intensity with which the energy is introduced is reduced to a level at which the formation of plasma from the substrate which is to be liquefied (either the material of the carrier band or the material of the layers which have previously been applied) is zero or negligibly low, and therefore below the threshold intensity, it is possible to achieve uniform application of the material of the desired composition satisfying all the requirements.

The invention is explained in more detail below with reference to the drawing, in which:

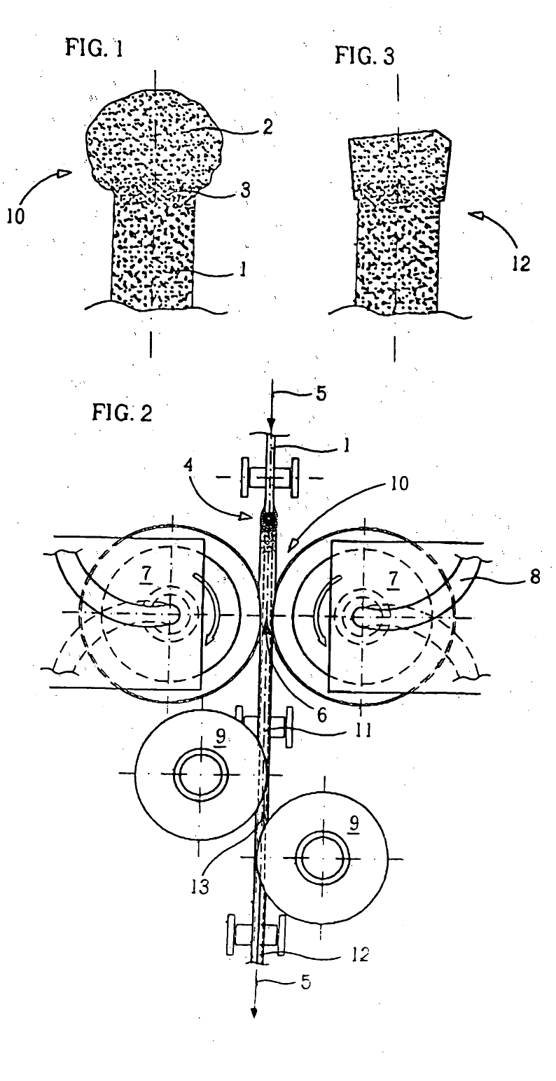

FIG. 1 shows a purely diagrammatic cross section through a carrier band and a cutting-edge region which has been melted onto it using the process described in the introduction, as obtained immediately after the process has been carried out,

FIG. 2 shows a purely diagrammatic plan view of an arrangement according to the invention, and

FIG. 3 shows a likewise purely diagrammatic possible cross-sectional form obtained after the process according to the invention has been carried out.

FIG. 1 shows a blank 10, comprising a carrier band 1 with a cutting-edge region 2 which has been applied to it by laser alloying. This cutting-edge region 2, on account of the high surface tension of the molten metal, has a virtually circular cross section. In a transition region 3 between the carrier band 1 and the cutting-edge region 2, the composition of the blank 10 gradually changes from the alloy of the carrier band 1 to the alloy of the cutting-edge region 2, as indicated by the different hatching.

In this case, both the transition region 3 and the cutting-edge region 2 substantially have a cast microstructure, since these regions have been formed by solidification from the melt. The object of the invention is to positively change this microstructure and the shape and size of the cross section, and this is achieved in the following way:

The carrier band 1, positioned on edge, is fed to the welding-on location 4 in the direction indicated by arrow 5, and at this welding-on location metal powder corresponding to the desired composition of the cutting-edge region 2 is fed to the carrier band in a manner known per se and is melted by a high-energy beam, generally a laser beam. In the illustration, details such as the formation of the bulk bed or nozzle for the powder and the arrangement and cooling for the laser and the creation of an inert-gas atmosphere in the region of the welding-on location 4 have been eliminated for reasons of clarity.

Immediately after it leaves the welding-on location 4, the blank 10 is in the form shown in FIG. 1, at a temperature just below the melting point of the alloy of the cutting-edge region 2. At this temperature, the blank passes into the working region 6, in which the cast microstructure and the cross section of the cutting-edge region 2 are changed. Two rolls or rollers 7, the distance between which in the cutting-edge region at least substantially corresponds to the desired thickness of the cutting-edge region, if appropriate with a slight oversize for the subsequent final treatment, are arranged in the working region 6. The two rolls 7 in this region do not have to be cylindrical, but rather, as indicated purely diagrammatically in FIG. 3, it is possible to create a wide range of shapes and dimensions by using a conical design of the rolls 7 in this region.

The rolls 7 are cooled, preferably internally, as indicated by line sections 8. At the prevailing temperatures, the rolls 7 have to be able to withstand the forces which are fundamentally defined by the composition of the blank 10 and the desired change in shape of the cutting-edge region 2, and this is achieved by using suitable dimensions and surface conditions. Additional external cooling, if appropriate even with liquid nitrogen, is also possible.

A semi-finished product 11 which already has the desired microstructure and at least substantially the desired cross section emerges from the working region 6. In the exemplary embodiment shown, a final region 13, in which the cutting-edge region 2 is converted into the desired final shape by means of two grinding wheels 9, is provided directly behind the working region 6. Since the semi-finished product 11 already substantially has the desired cross section (with an excess dimension which takes account of any reductions in the cross section of the blank but can be small on account of the working of the blank 10 in the working region 6 which at least partially compensates for differences), the volume of material which has to be removed is smaller by orders of magnitude than is the case in the prior art.

The invention is not restricted to the exemplary embodiment illustrated, but rather can be modified in various ways. For example, it is possible, in addition to the two rolls 7, for a thin disk or a disk with a thin edge to move from above into the region between the two rolls 7, so that the head region of the cutting-edge region 2 is also correspondingly deformed greatly in order to destroy the cast microstructure.

This may be advantageous in particular if, for example in the production of saws, the above-mentioned “constriction” is desired, creating a form of this type by means of a disk with a correspondingly shaped edge in combination with rolls 7 which are correspondingly designed not to be round. In this case, it is necessary for the two rolls 7 to be synchronized in their rotation by gear wheels or the like in order to reliably obtain the desired shape. In this case, the final region 13, if provided, will have different equipment, for example form cutters or shaped grinding wheels.

Another configuration relates to the option of providing a further heat treatment, for example inductive heating of the cutting-edge region, if appropriate with subsequent cold-rolling (under certain circumstances, this would also be possible without prior heating) before the subsequent grinding, instead of providing the final region 13.

It is easy for the person skilled in the art, when he is aware of the invention, to determine the level of working required to destroy the cast microstructure and to apply the cutting-edge region.

Purely by way of illustration, the following statements will be made concerning the materials which can be used: the base material used can be all known materials which are used as material for the carrier bands in bimetallic saws. By way of example, reference is made to the following overview of limit values:

| Constituent | % by weight |
|---|---|
| C | 0.15-0.60 |
| Si | <1.5 |
| Mn | <1.5 |
| Cr | 0.5-6.5 |
| Mo | 0.5-3 |
| W | <4 |
| V | 0.03-0.75 |
| Nb | <0.15 |
| Ni | <2.0 |
| Al | <0.15 |
| Co | <4.2 |
| Zr a/o Ti a/o Ta | <0.01 |
| B | <0.001 |
| Fe | Remainder |

With the proviso that 0.5<Mo+W/2<3, and that 0.03<V+Nb/2<0.75. An individual example which may be mentioned is an alloy containing: 0.34% C; 0.2% Si; 0.4% Mn; 2.9% Cr; 1% Mo; 0.4% Ni; 0.23% V; 0.1% W; 0.6% Al. The remainder to 100% by weight in the chemical composition of these alloys is formed by Fe and melting-related impurities.

The pulverulent constituents to be blown in are preferably of a size of 300 μm or below. These may be material powders based on Fe, Ni, Co, Ti, mixtures thereof or powder-metallurgy high-speed steels, stellites and carbides, nitrides, borides, oxides, mixtures thereof with the above-mentioned Fe-, Ni-, Co-, Ti-base alloys, PM-HSS, stellites, etc., what are known as hard-material systems.

The blanks produced in accordance with the invention can be subjected to a heat treatment, for example hardening, followed by tempering, as is customary in the case of high-speed steels. An example which may be mentioned is austenitization at approximately 1200° C. for about 2 minutes and tempering at 540° C. In the case of alloys which correspond to precipitation-hardenable materials (e.g. Fe-, Ni-, Co-base alloys), a solution anneal at between 1000 and 1200° C. and subsequent hot age-hardening at 450 to 750° C. can lead to the formation of the desired intermetallic phases.

Of course, it is also possible not to use a subsequent heat treatment if the carrier band has the desired properties and the composition is correct even before the tooth tip region or cutting-edge region is alloyed on.

The high-energy beam tools used are preferably lasers. It is in principle possible to use all known types of lasers, but CO₂ lasers are preferred on account of the good beam quality and high performance. However, it should also be noted at this point that in the not-too-distant future diode lasers will constitute a serious alternative. If it is particularly important for the laser beam to be guided by means of glass fibers, it is in particular also possible to use Nd-YAG lasers.

Of course, it is also possible to use other energy beams, such as electron beams, but laser beams are preferred on account of the high, readily controllable intensity.

In general, in the case of saws, the blanks as described in the present application are supplied to the actual saw manufacturers, who will machine the teeth out of the blanks and perform the required steps of cutting to length. Of course, there are also cases in which final production is carried out immediately after the blank has been produced.

The pulverulent constituent may be applied continuously over the entire length of the carrier band, but may also be applied in sections, in which case powder is welded onto the carrier band only in those regions in which the cutting edges or tooth tips are present in the finished cutting tool. It is in this way possible to save powder, less energy is required to weld on the powder and it is possible to increase the overall rate of advance during production if the regions in which no powder is applied are passed through more quickly.

1. A process for producing a cutting tool, in particular saws, cutting rules or cutting dies, comprising a carrier material (1) in strip or disk form, to whose edge, which is substantially standing on end, a cutting-edge region (2) in the form of a pulverulent alloy is applied and melted during the application, preferably by means of a laser beam, and then solidifies on the edge, wherein the cutting-edge region is subjected to a hot-working step in that region of the carrier material (1) with pulverulent material already applied in which this material is solidifying.

2. The process as claimed in claim 1, wherein the hot-working step affects the outer contour of the cutting-edge region, at least substantially the regions which project above the thickness of the carrier material.

3. The process as claimed in claim 1 or 2, wherein the hot-working step brings the outer contour of the cutting-edge region substantially into the desired final shape.

4. The process as claimed in one of the preceding claims, wherein the hot-working step is followed by heating at least of the cutting-edge region (2) and/or cold-rolling and/or grinding.

5. A device for carrying out the process as claimed in one of claims 1 to 4, wherein a working location (6), in which the cutting-edge region (2) of the blank (10) is hot-worked by rolls or rollers (7), is provided behind the location (4) where the metal powder is welded on, as seen in the direction of the relative movement between the carrier material and the welding-on location (4).

6. The device as claimed in claim 5, wherein the working location (6) is arranged in a region in which the cutting-edge region (2) of the blank (10) is at a temperature just below the melting point of its alloy.

7. The device as claimed in one of claims 5 and 6, wherein following the working location (6) there is a device for heating, in particular inductively heating, the cutting-edge region (2) and/or for cold-rolling and/or for grinding.

8. A process for producing a cutting tool, in particular saws, cutting rules or cutting dies, comprising a carrier material (1) in strip or disk form, to whose edge, which is substantially standing on end, a cutting-edge region (2) in the form of a pulverulent alloy is applied and melted during the application, preferably by means of a laser beam, and then solidifies on the edge, wherein the incidence of the laser beam on the material which is to be melted does not exceed the threshold intensity of the material for plasma formation.

9. The process as claimed in claim 8, wherein the pulverulent material is applied by the powder being blown into the region of the melted material.

10. The process as claimed in one of claims 8 and 9, wherein the laser beam is a CO₂ laser beam.

11. The process as claimed in one of claims 1 to 4 or 8 or 10, wherein that region of the carrier band or blank in which the material to be melted is in liquid form is held under a protective gas atmosphere.

12. A carrier band for use in the process as claimed in one of claims 1 to 4 or 8 to 11, which consists of an alloy within the following limits, in % by weight:
C: 0.15-0.60; Si<1.5; Mn:<1.5; Cr: 0.5-6.5;
Mo: 0.5-3; W:<4; V: 0.03-0.75; Nb:<0.15; Ni:<2.0;
Al:<0.15; Co:<4.2; Zr and/or, Ti and/or Ta:<0.01;
B:<0.001; with the proviso that 0.5<Mo+W/2<3 and 0.03<V+Nb/2<0.75, and that the remainder to 100% by weight in the chemical composition of these alloys is formed by Fe and melting-related impurities.

13. A pulverulent material which is to be blown in and is to be used in the process as claimed in one of claims 1 to 4 or 8 to 11, wherein the material is a material powder based on Fe, Ni, Co, Ti, mixtures thereof or alternatively powder metallurgy high-speed steels, stellites and carbides, nitrides, borides, oxides, mixtures thereof with the above-mentioned Fe-, Ni-, Co-, Ti-based alloys, PM-HSS, stellites, etc., known as hard-material systems.

14. A cutting tool or its blank, which has been produced using the process as claimed in one of claims 1 to 4 or 8 to 11.
